(19) United States
(12) Patent Application Publication
(10) Pub. No.: US 2004/0076857 A1
(43) Pub. Date: Apr. 22, 2004

(54) PVD coated cutting tool

(75) Inventors: Jacob Sjolen, Fagersta (SE); Lars Frisk, Fagersta (SE)

Correspondence Address: BURNS, DOANE, SWECKER & MATHIS, L.L.P., P.O. Box 1404, Alexandria, VA, 22313-1404, US

(73) Assignee: Seco Tools A B, Fagersta (SE)

(21) Appl. No.: 10/610,650

(22) Filed: Jul. 2, 2003

(30) Foreign Application Priority Data
Jul. 16, 2002 (SE) 0202230-9

(51) Int. Cl. B32B 9/00

(52) U.S. Cl. 428/701; 428/702; 428/698

(57) ABSTRACT

A cutting tool having a substrate and a coating has at least one layer having an X-ray diffraction pattern. The pattern shows the presence of a crystalline structure as well as of an amorphous structure. Preferably the layer comprises (Ti,Al)(O,N). The tool is particularly useful for machining steel, hardened steel or stainless steel, preferably milling of stainless steel. Associated methods are also described.

### FIELD OF THE INVENTION

The present invention relates to a cutting tool for machining by chip removal comprising a substrate of cemented carbide, cermet, ceramics, cubic boron nitride or high-speed steel and a hard and wear resistant refractory coating. The coating can be composed of one or more layers of refractory compounds of which at least one layer comprises a dense layer containing a mixture of an amorphous and a crystalline phase, such as a (Ti,Al)(O,N)-layer.

### BACKGROUND OF THE INVENTION

In the description of the background of the present invention that follows reference is made to certain structures and methods, however, such references should not necessarily be construed as an admission that these structures and methods qualify as prior art under the applicable statutory provisions. Applicants reserve the right to demonstrate that any of the referenced subject matter does not constitute prior art with regard to the present invention.

U.S. Pat. No. 4,474,849 discloses coated hard alloys excellent in toughness and wear resistance which comprise a substrate of hard alloy and at least one layer thereon, at least one of the layers being of amorphous alumina.

U.S. Pat. No. 5,330,853 discloses a coated surface with alternating first and second ternary layers, wherein the first layer TiAlNₓ has a higher nitrogen content and is considerably thinner than the second layer TiAlN_{y}. The layers are deposited using sputtering of a TiAl target.

U.S. Pat. No. 5,549,975 discloses a coated tool consisting of a cermet body, coated with a wear resistant layer of (Ti, Me) N, wherein Me is at least one metal which forms a stable oxide at a temperature above 700° C. The deposition process is a combination of evaporation and sputtering.

U.S. Pat. No. 5,503,912 disclose a coating formed of ultra-thin layers comprising at least one nitride or carbonitride of at least one element selected from the group consisting of the elements in the Groups IVa, Va and VIa in the periodic table, as well as Al and B. The overall compound having a cubic crystalline X-ray diffraction pattern, in spite of the fact that one of the layers having a crystal structure other than the cubic crystal structure at normal temperature and normal pressure and under an equilibrium state. This coating is in practice a laminate of TiN and AlN where each layer has a thickness of 0.2-50 nm.

U.S. Pat. No. 5,879,823 discloses coated cutting tool with an innermost layer of a Group IVB metal-aluminium alloy, and a second layer of alumina applied by physical vapour deposition.

U.S. Pat. No. 6,254,984 discloses a multi-layer-coated consisting of first layers each composed of at least one of carbides, nitrides and carbonitrides of elements of Groups 4a, 5a and 6a of the Periodic Table and Al, and two or more second layers each composed of at least one of oxides, carboxides, oxinitrides and carboxinitrides of elements of Groups 4a, 5a and 6a of the Periodic Table and Al, laminated alternately. The first layers adjacent the second layers are continuous in crystal orientation. In the description is also an outer amorphous layer deposited in order to increase the oxidation resistance

U.S. Pat. No. 6,071,560 discloses a wear resistant coating containing at least one layer of MeX, where Me comprises titanium and aluminium and X is nitrogen or carbon. In the MeX layer, the texture measured with X-ray diffraction is preferably (200).

R. Luthier and F. Levy, J. Vac. Sci. Technol., A9 (1) (1991) 102 have grown TiAlON layers by rf magnetron sputtering from a ceramic target consisting of TiN—Al₂O₃. They obtained a mixed structure consisting of (Ti,Al)Nₓ and amorphous (Ti,Al)O₂. The obtained XRD patterns from those layers consist of peaks originating from crystalline phase together with an amorphous hump.

K. Kawata, H. Sugimura, and O. Takai, Thin Solid Films 390 (2001) 64 have grown different Ti—Al—O—C—N layers using plasma-enhanced chemical vapor deposition (PACVD).

Several authors have reported formation of crystalline or amorphous layers on top of (Ti,Al)N spontaneously formed during a post-oxidation step or usage at elevated temperature, see e.g. Münz et al, J. Vac. Sci. Technol. 4 (6) (1986)2717-2727.

### SUMMARY OF THE INVENTION

It is an object of this invention to improve several properties known from the prior art, such as oxidation resistance, surface roughness, layer toughness and wear resistance.

It has now been found that a coated cutting tool provided with a coating that comprises one or several layers, of which one or at least one layer has a crystalline structure combined with an amorphous structure, has an improved wear resistance and toughness compared to prior art coatings.

According to one aspect, the present invention provides a cutting tool insert comprising a substrate and a coating, the coating having a thickness of 0.3-20 μm and containing at least one layer having an X-ray diffraction pattern, wherein the pattern shows the presence of a crystalline structure with narrow peaks, a highest peak with height P, as well as an amorphous structure with a broad peak having a height H, wherein H>3B and P>5B and 0.75<P/H<3, wherein B is the Chebychev radiation.

According to another aspect, the present invention provides a method for producing a coated cutting tool comprising at least one layer of (Ti,Al) (O,N), wherein the (Ti,Al) (O,N)-layer is deposited by arc-evaporation of TiAl-targets having a compositional ratio value of 0.2<.R_{ME}<0.7, wherein R_{ME} is the at. % ratio of Ti/(Ti+Al), in a reactive atmosphere containing N₂, O₂ and Ar at a total pressure, P, set to 1.0<P<10 Pa, with a ratio R=O₂/(N₂+O₂), wherein 0.05<R<0.15.

### BRIEF DESCRIPTION OF THE DRAWINGS

FIG. 1 shows an X-ray diffraction pattern from a layer formed according to the present invention.

FIG. 2 shows a SEM-micrograph of a cross-section from a sample formed according to the invention.

FIG. 3 shows θ−2θ x-ray diffraction scans 20°<90° from layers with different oxygen contents.

### DETAILED DESCRPTION OF THE INVENTION

The present invention thus relates to a cutting tool comprising a coating and a substrate. The substrate comprises a cemented carbide, cermet, high-speed steel or cubic boron nitride. The coating is composed of one or several layers of which at least one layer is composed of a crystalline structure combined with an amorphous structure. Said layer has a thickness of 0.3-20 μm, preferably 0.3-10 μm. The total coating thickness is 0.5-20 μm.

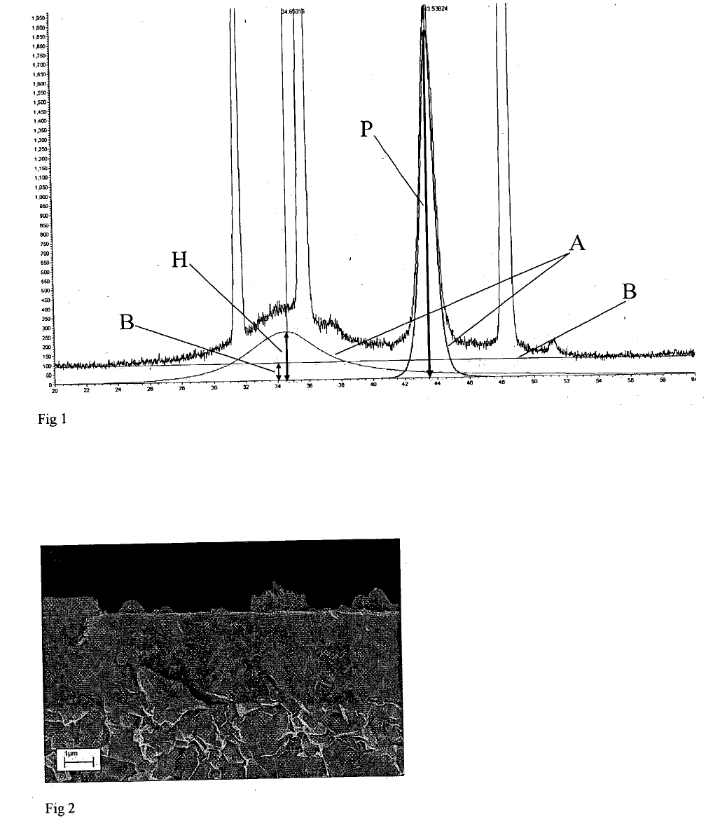

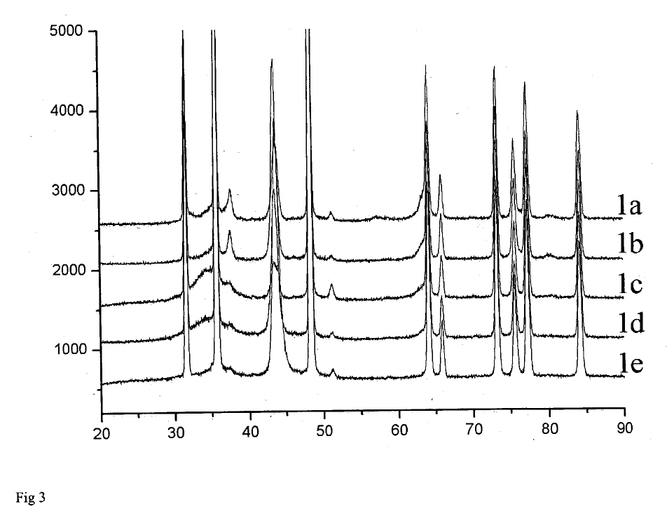

The structure of the coating is quantified with respect to the background level, B, the height of the amorphous peak, H, and the height of the highest peak from the crystalline structure P, using Cu K a -radiation (λ=1.54 Å), see FIG. 1. A SPVII-curve fitting algorithm [1,2] is used to extract data for both the amorphous peak and the crystalline peak.

The Chebychev background radiation [1,2], B, is calculated between 20°<2θ<60°.

According to the invention H>3B and P>5B and 0.75<P/H<3.

Preferably the coating is a (Ti,Al)(N,O)-layer having a crystalline (Ti,Al)N-osbornite (NaCl) structure in combination with an amorphous structure.

The amorphous structure is identified by a broad peak between 20°<2θ<48° with 4°<FWHM<7°. The amorphous structure results in Bragg reflections at 30°<2θ<40° preferably 32°<2θ<38° which corresponds to atomic distances between 1.9 Å-4.4 Å with a maximum, H, centered at an atomic distance of 2.5 Å.

The crystalline NaCl-structure of (Ti,Al)N is identified by the reflections from the (111)-, (200)- and (220)-planes, corresponding to positions 2θ=37.5°, 43.5° and 63.5° respectively, in a θ−2θ scan using Cu—Kα radiation.

The coating according to the present invention can be deposited directly on to the substrate or on one or more interlayers as known in the art. Likewise further layers can be deposited on top of the coating.

The (Ti,Al)(O,N)-layer, when it is a single layer, is also characterized by a smooth surface with a small amount of droplets having a small size, surface roughness Rₐ<0.2 μm measured over a length of 2.5 mm with a stylus method.

The composition of the (TiₓAl₁₋ₓ)(O_{y},N_{1-y}) layer is 0.20<x<0.70 and 0.15<y<0.35, preferably 0.25<x<0.55 and 0.20<y<0.30 using a quantitative EDX measurement method with ZAF correction at 10 kV and 25 mm working distance.

The coating is deposited by arc-evaporation of metallic TiAl-targets, with a R_{Me}=Ti % at/(Ti % at+Al % at)-ratio, 0.20<R_{Me}<0.70, using an evaporator current, I_{EVAP}, set to 6×100 A in a reactive atmosphere containing N₂, O₂ and Ar, with a ratio R_{Gas}=O₂/(N₂+O₂), 0.05<R<0.15 and a total pressure, P, set to 1.0<P<10 Pa during deposition. The applied bias voltage, U_{BIAS}, is −30<U_{BIAS}<−600 V.

The exact process parameters are dependent on the design of the coating equipment used. It is within the purview of the skilled artisan to determine whether the inventive structure has been obtained and to modify the deposition conditions in accordance with the teachings of the present specification.

The coated cutting tool according to the invention is particularly useful for machining steel, hardened steel or stainless steel, preferably milling of stainless steel.

The principles of the present invention will now be further described by reference to the following illustrative, non-limiting examples.

### EXAMPLE 1

(Ti,Al)(O,N)-layers were deposited in a commercially available arc evaporation deposition system designed for thin film deposition.

Mirror-polished cemented carbide substrates with composition 6 wt % Co and 94 wt % WC were used for analysis. Inserts used for cuttings tests were coated in the same batches.

Before deposition, the substrates were cleaned in ultrasonic baths of an alkali solution, in deionized water and in alcohol. The substrates were mounted on a rotating fixture. The minimum distance between cathodes and substrates was approximately 100 mm.

The substrates were heated by infrared heaters for 20 minutes prior to the actual coating process.

The subsequent (Ti,Al)(O,N)-deposition was carried out at varying gas-mixtures R_{Gas}=O₂/(N₂+O₂), R_{Gas}=0, 0.026, 0.079, 0.18 and 0.24. The evaporator current was set to 6×100A, the substrate bias was −120 V and the total pressure was 2.0 Pa. The temperature during the coating process was 520° C., measured with two infrared pyrometers.

The resulting thickness of the coatings was 4.0 μm.

The substrate current density was 1.2 mA/cm².

XRD analysis showed that all films exhibited the cubic osbornite structure. For the layers with low levels of oxygen in the coating process, a broad peak from an amorphous structure was also found. The amorphous structure was most prominent for the ratios φO₂/(φN₂+φO₂)=0.079, and 0.18, corresponding to a measured oxygen content in the layer of 10% at, and 22% at respectively, using an EDX measurement method.

SEM studies of fracture cross-sections revealed columnar structure for layers deposited with low oxygen levels, φO₂/(φN₂+φO₂)=0 and 0.026, resulting in oxygen levels in the coating of 2% at and 10% at respectively. The structure vanished as the oxygen level increased (FIG. 2). The intensities of the amorphous peaks H/B are listed in table below.

The hardness and Young's modulus was measured by nanoindentation. The results are listed in the table below. The hardness and Young's modulus decreases with increasing levels of oxygen in the layer, hence the toughness is improved by adding oxygen in the process.

The adhesion and toughness were measured using a reve test. A diamond stylus was used with loads ranging from 10-100 N. All layers showed a very good adhesion (>60 N), layers with high levels of oxygen were less brittle than layers with low amounts of oxygen. The reve test demonstrates that layers according to present invention have strongly enhanced toughness properties compared to layers grown without oxygen.

The surface roughness, Ra, was measured with a stylus profilometer, using a Perthometer instrument. The surface roughness of the uncoated substrates was Ra<5 nm measured with AFM (Atomic Force Microscope), which does not influence the result of the roughness parameters of the layers. It is obvious that the surface roughness decreases when increasing the oxygen content, see Table 1. The significant difference in surface roughness is found when layers with and without oxygen are compared.

TABLE 1
Oxygen levels and properties of the (Ti,Al)(O,N) layers.

| | | H | E | Ra | | | |
|---|---|---|---|---|---|---|---|
| Label | φO₂/(φN₂ + φO₂) | [GPa] | [GPa] | [μm] | H/B | P/B | Structure |
| 1a | 0 | 34.7 | 600 | 0.26 | 1.9 | 12.1 | Columnar |
| 1b | 0.026 | 28.8 | 420 | 0.16 | 1.5 | 29.9 | Columnar |
| 1c | 0.079 | 31.1 | 440 | 0.15 | 5.8 | 6.5 | Fine grained <0.1 μm |
| 1d | 0.18 | N/A | N/A | 0.12 | 4.7 | 20.2 | Fine grained <0.1 μm |
| 1e | 0.24 | N/A | N/A | 0.09 | 2.9 | 38.2 | Fine grained <0.1 μm |

### EXAMPLE 2

Inserts of the same type as the ones used in Example 1 were coated with a binary layer structure composed of a (Ti,Al)N-layer with columnar structure followed by a layer of mixed amorphous and crystalline structure composed of (Ti,Al)(O,N).

The pretreatment of the inserts before coating was performed in the same way as in Example 1. The coating process was carried out in N₂-atmosphere at 2.0 Pa, while TiAl was evaporated from six cathodes. The substrates were biased at −120 V and the evaporator current was set to 6×100A. The deposition temperature was 520° C. The thickness of this layer was 2.0 μm.

The second layer of the coating was identical to 1c of Example 1.

The total thickness of the coating was 4.0 μm.

It is possible to distinguish the bilayered coating from a single layer by gracing incidence XRD-scan. It is within the purview of the skilled artisan to set up the parameters for such an analysis.

This coating is herein referred to as 2a.

### EXAMPLE 3

A cemented carbide cutting tool insert with the composition 6% wt Co, 0.5% wt TaC and 93.5% wt WC with different coatings were used in a turning operation in steel (SS1672, AISI-1042, DIN-Ck 45).

Coatings:

The coatings described in example 1, example 2 and two types of coatings known from prior art, i.e.—TiN and (Ti,Al)N coatings, were compared.

Cutting data

Insert geometry SNUN120408

Cutting speed 250 m/min

Cutting depth 1.5 mm

Cutting feed 0.35 mm

Results (Tool life)

| | | |
|---|---|---|
| 1a | 20 minutes | outside invention |
| 1b | 28 minutes | outside invention |
| 1c | 32 minutes | invention |
| 1d | 16 minutes | outside invention |
| 1e | 10 minutes | outside invention |
| 2a | 22 minutes | invention |
| TiN | 12 minutes | prior art |
| (Ti, Al)N | 18 minutes | prior art |

### EXAMPLE 4

A cemented carbide cutting insert with the composition 13% wt Co and 87% wt WC with different coatings, described in example 1 and example 2, were used in a square shoulder milling operation in stainless steel (SS2343, AISI-316, DIN-X5 CrNiMo 17 13 3).

Cutting data

Insert geometry XOMX090308TR-ME06

Cutting speed 260 m/min

Cutting depth 3.0 mm

Cutting feed 0.23 mm

Cutting width 5 mm

Tool life criterion was destruction of the cutting edge due to chipping, which was caused by built up edge. The test result shows that the insert with the bi-layered coating, described in example 2, showed longer tool life compared to the same substrate coated with other coatings.

| Results | (Tool life) in minutes |
|---|---|
| 1a | 14 outside invention |
| 1b | 12 outside invention |
| 1c | 12 invention |
| 1d | 8 outside invention |
| 1e | 6 outside invention |
| 2a | 16 invention |
| TiN | 8 prior art |
| (Ti, Al)N | 14 prior art |

### EXAMPLE 5

A solid carbide drill with the composition 10% wt Co and 90% wt WC with different coatings, described in example 1 and example 2, were used in a bottomless hole drilling operation in steel (SS1672, AISI-1042, DIN-Ck 45).

Cutting data

Drill type SD25-6.0-32-6R5

Cutting speed 80 m/min

Cutting depth 24 mm

Cutting feed 0.16 mm

| Results | (Tool life) in number of holes | |
|---|---|---|
| 1a | 1000 | outside invention |
| 1b | 1200 | outside invention |
| 1c | 1600 | invention |
| 1d | 600 | outside invention |
| 1e | 200 | outside invention |
| 2a | 1000 | invention |

While the present invention has been described by reference to the above-mentioned embodiments, certain modifications and variations will be evident to those of ordinary skill in the art. Therefore, the present invention is limited only by the scope and spirit of the appended claims.

We claim:

1. A cutting tool insert comprising a substrate and a coating, the coating having a thickness of 0.3-20 μm and containing at least one layer having an X-ray diffraction pattern, wherein the pattern shows the presence of a crystalline structure with narrow peaks, a highest peak with height P, as well as an amorphous structure with a broad peak having a height H, wherein H>3B and P>5B and 0.75<P/H<3, wherein B is the Chebychev background radiation.

2. The cutting tool insert according to claim 1, the crystalline structure is cubic.

3. The cutting tool insert according to claim 1, wherein the at least one layer comprises (Ti,Al) (O,N).

4. The cutting tool insert according to claim 3, wherein the (Ti,Al) (O,N)-layer has a composition such that the (TiₓAl₁₋ₓ)(O_{y},N_{1-y}) layer is 0.20<x<0.70 and 0.15<7<0.35.

5. The cutting tool insert according to claim 1, wherein the at least one layer is the outermost layer of the coating.

6. The cutting tool insert according to claim 1, wherein the substrate comprises cemented carbide, cermet, ceramics or cubic boron nitride.

7. A method for producing a coated cutting tool comprising at least one layer of (Ti,Al) (O,N), wherein the (Ti,Al) (O,N)-layer is deposited by arc-evaporation of TiAl-targets having a compositional ratio value of 0.2<.R_{ME}<0.7, wherein R_{ME} is the at. % ratio of Ti/(Ti+Al) in a reactive atmosphere containing N₂, O₂ and Ar at a total pressure, P, set to 1.0<P<10 Pa, with a ratio R=O₂/(N₂+O₂) wherein 0.05<R<0.15.

8. The cutting tool insert according to claim 2, wherein the crystalline structure is osbornite.
